(19) United States
(12) Patent Application Publication
(10) Pub. No.: US 2019/0309759 A1
(43) Pub. Date: Oct. 10, 2019

(54) COMPRESSOR, AND METHOD FOR PRODUCING BLADE THEREOF

(71) Applicant: MITSUBISHI HEAVY INDUSTRIES, LTD., Tokyo (JP)

(72) Inventors: Thomas WALKER, Tokyo (JP); Ryosuke MITO, Tokyo (JP)

(21) Appl. No.: 16/461,041

(22) PCT Filed: Nov. 17, 2017
(86) PCT No.: PCT/JP2017/041457

§ 371 Date: Jun. 21, 2019

Related U.S. Application Data
(60) Provisional application No. 62/424,029, filed on Nov. 18, 2016.
(60) Provisional application No. 62/424,022, filed on Nov. 18, 2016.

(51) Int. Cl. F04D 19/02; F04D 29/18

(52) U.S. Cl. CPC F04D 19/022; F05B 2230/10; F04D 29/181

(57) ABSTRACT

A tip portion of a compressor blade faces a casing with a clearance therebetween. The tip portion has an upstream-side region including a blade leading edge, and a downstream-side region including a blade trailing edge. The upstream-side region has a small clearance formation portion including a part in which the clearance is a minimum in the tip portion. The downstream-side region forms a large clearance formation portion having a clearance larger than a clearance of the small clearance formation portion throughout the entire region of the downstream-side region.

Priority is claimed on U.S. Patent Provisional Application No. 62/424,022, filed Nov. 18, 2016, and U.S. Patent Provisional Application No. 62/424,029, filed Nov. 18, 2016, the contents of which are incorporated herein by reference.

### TECHNICAL FIELD

The present invention relates to a compressor and a method for producing a blade thereof.

### BACKGROUND ART

A compressor includes a rotor that rotates about an axis, and a casing that covers an outer circumferential side of this rotor. The rotor has a rotary shaft portion extending in an axial direction about the axis, and a plurality of blades provided in the rotary shaft portion at intervals in a circumferential direction. Each of the plurality of blades has a leading edge, a trailing edge, a positive pressure surface, a negative pressure surface, and a tip portion. The tip portion faces the casing with a clearance therebetween.

Since the blades rotate about the axis, there is a need for the tip portions of the blades and the casing which is a stationary body to have a clearance therebetween. When there is this clearance, in a first blade and a second blade, and a third blade arranged in the circumferential direction, for example, a portion of a gas flowing between the first blade and the second blade passes through the clearance between the second blade and the casing and flows into a space between the second blade and the third blade. A leakage gas which is a gas passing through the clearance between the second blade and the casing hinders a flow of a gas flowing between the second blade and the third blade. Therefore, when the momentum of a leakage gas increases, performance of the compressor deteriorates.

In the following Patent Literature 1, the momentum of a leakage gas is curbed by forming a plurality of grooves in a tip portion.

### CITATION LIST

### Patent Literature

### [Patent Literature 1]

Specification of United States Patent Application, Publication No. 2014/0186190

### SUMMARY OF INVENTION

### Technical Problem

An object of the present invention is to provide a technology for curbing deterioration in performance of a compressor caused by the influence of a leakage gas while ensuring a clearance between a casing and a blade.

### Solution to Problem

According to an aspect of the invention for achieving the foregoing object, a compressor is provided, including a rotor that is configured to rotate about an axis, and a casing that covers an outer circumferential side of the rotor. The rotor has a rotary shaft portion rotating about the axis, and a plurality of blades provided in the rotary shaft portion at intervals in a circumferential direction with respect to the axis. Each of the plurality of blades has a leading edge forming an edge in an axial direction in which the axis extends; a trailing edge forming an edge on a side opposite to the leading edge; a positive pressure surface and a negative pressure surface connecting the leading edge and the trailing edge to each other, being directed in a direction including a component of the circumferential direction, and having a back-to-back relationship therebetween; and a tip portion connecting the leading edge and the trailing edge to each other and facing the casing with a clearance therebetween. The tip portion has an upstream-side region including the leading edge, and a downstream-side region including the trailing edge. The upstream-side region has a small clearance formation portion including a part in which the clearance is a minimum in the tip portion. The downstream-side region extends from an edge of the small clearance formation portion on the trailing edge side to the trailing edge. The downstream-side region forms a large clearance formation portion having a clearance larger than the clearance of the small clearance formation portion throughout the entire region of the downstream-side region.

In the compressor of the present aspect, since the small clearance formation portion is formed in the upstream-side region, a position of a maximum momentum generated by a leakage gas which has passed through a clearance of a certain blade deviates to the trailing edge side. Therefore, in the present aspect, it is possible to reduce the influence of this leakage gas on another blade adjacent to the certain blade.

Here, in the compressor of the aspect, a position of a smallest clearance which is a minimum value for the clearance may be a position at a distance within a range of 5% to 60% of a chord length of the blade from the leading edge in a chord direction in which a chord of the blade extends.

In addition, in the compressor, the position of the smallest clearance may be a position at a distance within a range of 10% to 60% of the chord length from the leading edge in the chord direction.

In the compressor according to any one of the foregoing aspects, the smallest clearance which is the minimum value for the clearance may be equal to or larger than 0.4% of the chord length of the blade.

In addition, in the compressor according to any one of the foregoing aspects, an edge of the small clearance formation portion on the leading edge side may be at a position at a distance within a range of 0% to 25% of the chord length of the blade from the leading edge in the chord direction in which the chord of the blade extends.

In the compressor according to any one of the foregoing aspects, the small clearance formation portion may be present up to a position at a distance within a range of 10% to 60% of the chord length from the leading edge in the chord direction in which the chord of the blade extends.

In the compressor according to any one of the foregoing aspects, in the blade, the clearance may smoothly change from the leading edge to the position of the smallest clearance which is the minimum value for the clearance.

In the compressor according to any one of the foregoing aspects, the small clearance formation portion may include a position where a vane thickness which is an interval between the positive pressure surface and the negative pressure surface is a maximum in the chord direction in which the chord of the blade extends.

In the present aspect, even if the small clearance formation portion is formed, it is possible to curb deterioration in vibration characteristics and strength characteristics of the blades.

In the compressor according to any one of the foregoing aspects, in the small clearance formation portion, the clearance may change in accordance with the position in the circumferential direction.

In the present aspect, even if the small clearance formation portion and the casing come into contact with each other, only a portion of the small clearance formation portion in the circumferential direction comes into contact therewith, so that it is possible to curb damage to the small clearance formation portion caused by contact therebetween.

In the compressor according to any one of the foregoing aspects, the small clearance formation portion may be present in only a portion in the upstream-side region in the circumferential direction.

In the present aspect, even if the small clearance formation portion and the casing come into contact with each other, only a portion of the tip portion in the circumferential direction comes into contact therewith, so that it is possible to curb damage to the tip portion caused by contact therebetween. Moreover, in the present aspect, it is possible to reduce the vane thickness of the tip portion.

In the compressor according to any one of the foregoing aspects, the small clearance formation portion may have better abradable properties than a part in the blade excluding the small clearance formation portion.

In the present aspect, even if the small clearance formation portion and the casing come into contact with each other, it is possible to curb damage to the casing.

The compressor according to any one of the foregoing aspects may further include a plurality of stator vane rows that are disposed at intervals in the axial direction. All of the plurality of stator vane rows may have a plurality of stator vanes fixed to the casing at intervals in the circumferential direction. The rotor may have a plurality of blade rows disposed at intervals in the axial direction. Each of the plurality of blade rows may be disposed on an axial upstream side of any stator vane row of the plurality of stator vane rows. All of the plurality of blade rows may have a plurality of blades provided in the rotary shaft portion at intervals in the circumferential direction.

According to another aspect of the invention for achieving the foregoing object, a method is provided for producing a blade which rotates in a circumferential direction with respect to an axis about the axis inside a casing of a compressor. The method for producing a blade executes an intermediate product-forming step of forming an intermediate product of the blade, and a machining step of machining the intermediate product. The intermediate product formed in the intermediate product-forming step has a leading edge forming an edge in an axial direction in which the axis extends; a trailing edge forming an edge on a side opposite to the leading edge; a positive pressure surface and a negative pressure surface connecting the leading edge and the trailing edge to each other, being directed in a direction including a component of the circumferential direction, and having a back-to-back relationship therebetween; and an unmachined tip portion facing the casing. In the machining step, the unmachined tip portion of the intermediate product is machined, the leading edge and the trailing edge are connected to each other, and a machined tip portion facing the casing with a clearance therebetween is formed. The machined tip portion has an upstream-side region including the leading edge, and a downstream-side region including the trailing edge. The upstream-side region has a small clearance formation portion including a part in which the clearance is a minimum in the tip portion. The downstream-side region extends from the edge of the small clearance formation portion on the trailing edge side to the trailing edge. The downstream-side region forms a large clearance formation portion having a clearance larger than the clearance of the small clearance formation portion throughout the entire region of the downstream-side region.

In a blade produced by the method of the present aspect, the small clearance formation portion is formed in the upstream-side region. Therefore, a position of a maximum momentum generated by a leakage gas which has passed through a clearance of a certain blade deviates to the trailing edge side. Therefore, it is possible to reduce the influence of this leakage gas on another blade adjacent to the certain blade.

Here, in the method for producing a blade of the aspect, in the intermediate product-forming step, the intermediate product may be formed such that the clearance of the unmachined tip portion becomes the same clearance as a largest clearance in the large clearance formation portion of the machined tip portion throughout the entire region of the unmachined tip portion in a chord direction in which a chord of the intermediate product extends. In the machining step, the small clearance portion may be formed by forming a part which becomes the small clearance formation portion in the unmachined tip portion, as a ridge with a material for forming the small clearance formation portion.

In the method for producing a blade ridged with a material for forming the small clearance formation portion, a material having better abradable properties than a material for forming the intermediate product may be used as the material for the small clearance formation portion.

In the method for producing a blade of the aspect, in the intermediate product-forming step, the intermediate product may be formed such that the clearance of the unmachined tip portion becomes equal to or less than a smallest clearance in the small clearance formation portion of the machined tip portion throughout the entire region of the unmachined tip portion in a chord direction in which a chord of the intermediate product extends. In the machining step, the large clearance formation portion may be formed by cutting a part which becomes the large clearance formation portion in the unmachined tip portion.

### Advantageous Effects of Invention

According to the aspect of the present invention, it is possible to curb deterioration in performance of the compressor caused by an influence of a leakage gas while ensuring a clearance between the casing and the blade.

### BRIEF DESCRIPTION OF DRAWINGS

FIG. 1 is a cross-sectional view of a part of a compressor in a first embodiment according to the present invention.

FIG. 2 is a side view of a part of a blade in a first embodiment according to the present invention.

FIG. 3 is a side view of a part of an intermediate product in the first embodiment according to the present invention.

FIG. 4 is a cross-sectional view of a part of the blade in the first embodiment according to the present invention.

FIG. 5 is a graph illustrating a relationship between a distance from a leading edge and a momentum of a leakage gas in blades of various kinds including the blade in the first embodiment according to the present invention.

FIG. 6 is a graph illustrating a stage effect of the blade in the example of the first embodiment according to the present invention and a blade in a comparative example.

FIG. 7 is a cross-sectional view of a part of a compressor in the comparative example.

FIG. 8 is a side view of a part of the blade in the comparative example.

FIG. 9 is a graph illustrating a relationship between a distance from a leading edge and a momentum of a leakage gas in blades in a plurality of comparative examples differing from each other in nominal clearance.

FIG. 10 is a side view of a part of a blade in a first modification example of the first embodiment according to the present invention.

FIG. 11 is a view of a blade in a second modification example of the first embodiment according to the present invention viewed from a radial outer side.

FIG. 12 is a cross-sectional view of parts of blades in various modification examples of the first embodiment according to the present invention. FIG. 12(A) is a cross-sectional view of a part of a blade in a third modification example. FIG. 12(B) is a cross-sectional view of a part of a blade in a fourth modification example. FIG. 12(C) is a cross-sectional view of a part of a blade in a fifth modification example. FIG. 12(D) is a cross-sectional view of a part of a blade in a sixth modification example. FIG. 12(E) is a cross-sectional view of a part of a blade in a seventh modification example. FIG. 12(F) is a cross-sectional view of a part of a blade in an eighth modification example.

FIG. 13 is a side view of a part of a blade in a second embodiment according to the present invention.

FIG. 14 is a cross-sectional view of parts of blades in various modification examples of the second embodiment according to the present invention. FIG. 14(A) is a cross-sectional view of a part of a blade in a first modification example. FIG. 14(B) is a cross-sectional view of a part of a blade in a second modification example. FIG. 14(C) is a cross-sectional view of a part of a blade in a third modification example. FIG. 14(D) is a cross-sectional view of a part of a blade in a fourth modification example.

FIG. 15 is a cross-sectional view of a part of a compressor in a third embodiment according to the present invention.

FIG. 16 is a cross-sectional view of a part of a compressor in a fourth embodiment according to the present invention.

### DESCRIPTION OF EMBODIMENTS

Hereinafter, various embodiments of a compressor will be described using the drawings.

### First Embodiment

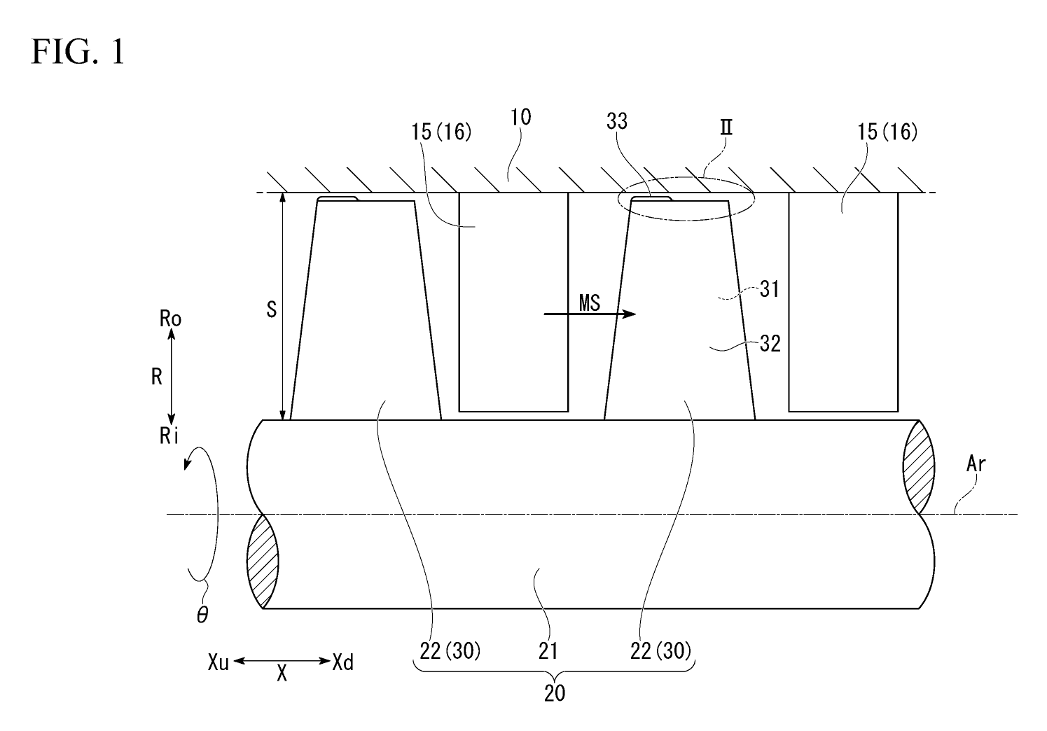

With reference to FIGS. 1 to 9, a first embodiment of the compressor will be described.

First, a compressor of the comparative example will be described before describing the compressor of the present embodiment.

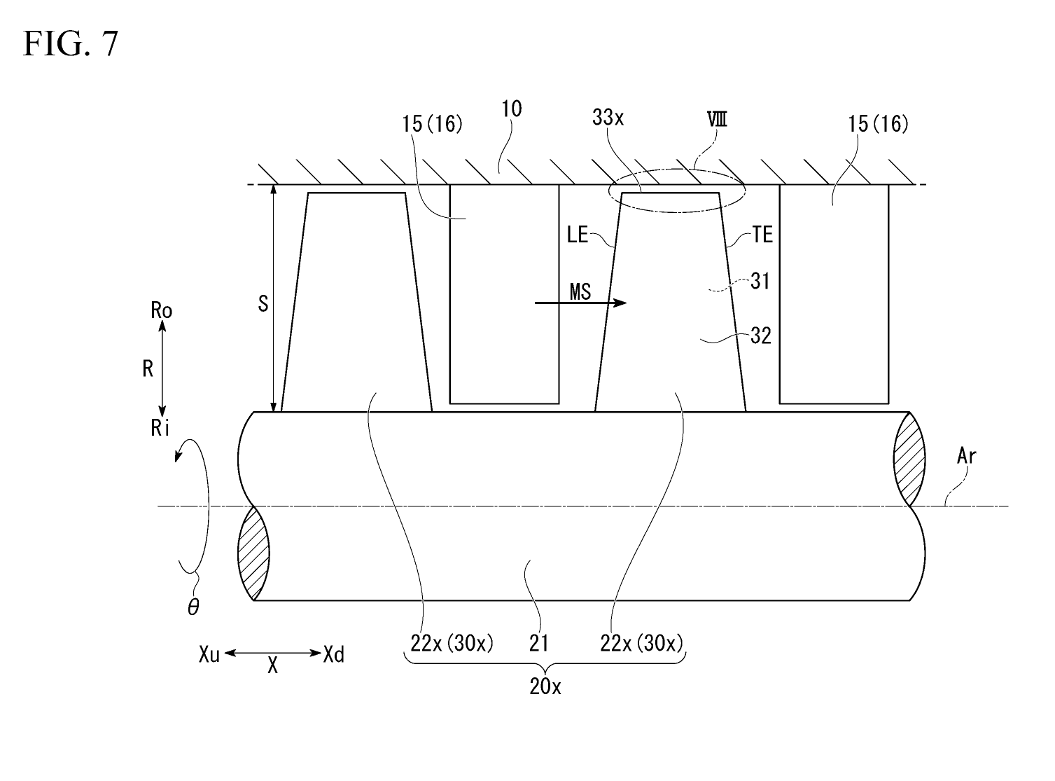

The compressor of the comparative example is an axial compressor. As illustrated in FIG. 7, this compressor includes a rotor 20x that rotates about an axis Ar, a casing 10 that covers an outer circumferential side of the rotor 20x, and a plurality of stator vane rows 15. Here, a direction in which the axis Ar extends will be referred to as an axial direction X. One side in this axial direction X will be referred to as an axial upstream side Xu, and the other side in this axial direction X will be referred to as an axial downstream side Xd. In addition, a side toward the axis Ar in a radial direction R with respect to the axis Ar will be referred to as a radial inner side Ri, and a side opposite thereto will be referred to as a radial outer side Ro. In addition, a circumferential direction with respect to the axis Ar will be simply referred to as a circumferential direction θ. In the axial compressor, the axial upstream side Xu is the upstream side of a main stream MS of a compressed gas, and the axial downstream side Xd is the downstream side of the main stream MS.

The rotor 20x has a rotary shaft portion 21 extending in the axial direction X about the axis Ar, and a plurality of blade rows 22x provided in the rotary shaft portion 21 at intervals in the axial direction X. All of the blade rows 22x have a plurality of blades 30x arranged in the circumferential direction θ.

Each of the plurality of stator vane rows 15 is disposed on the axial downstream side Xd of any blade row 22x of the blade rows 22x. All of the stator vane rows 15 have a plurality of stator vanes 16 arranged in the circumferential direction θ. All of the plurality of stator vanes 16 are fixed to the casing 10.

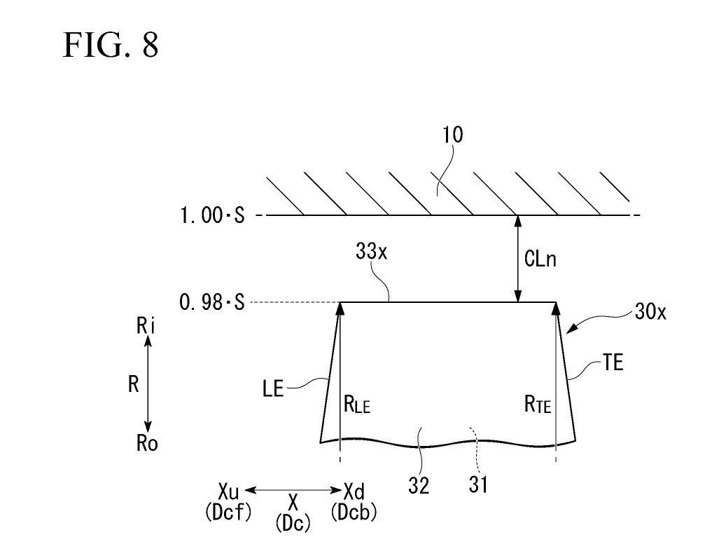

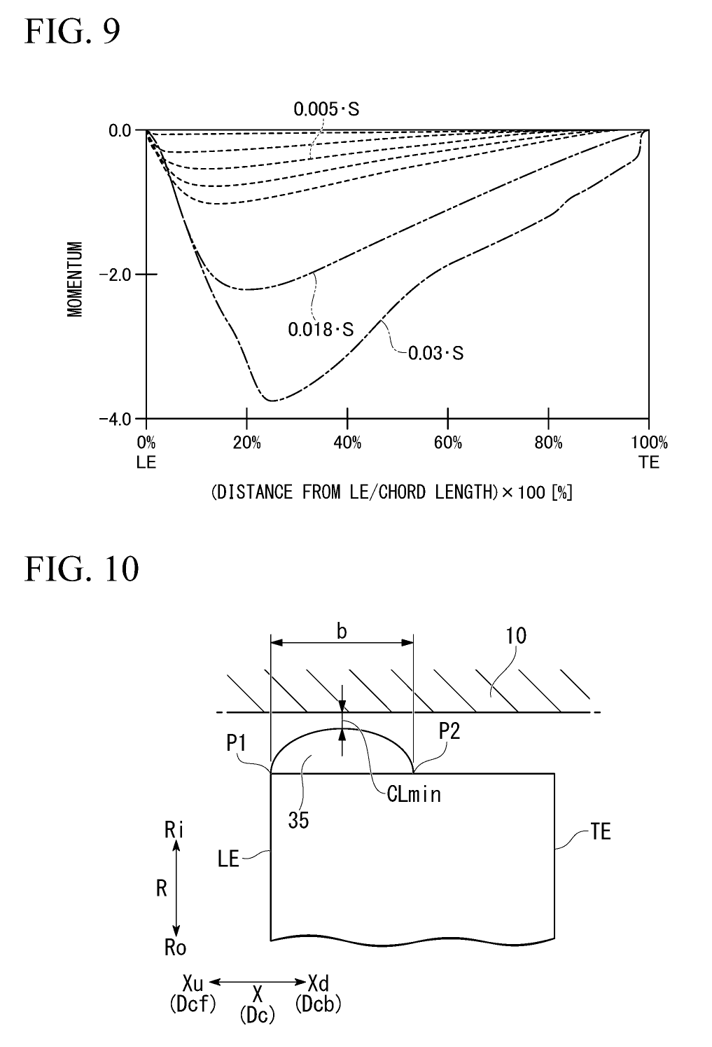

As illustrated in FIG. 8, the blade 30x has a leading edge LE, a trailing edge TE, a positive pressure surface 31, a negative pressure surface 32, and a tip portion 33x. The leading edge LE forms an edge of the blade 30x on the axial upstream side Xu. The trailing edge TE forms an edge of the blade 30x on the axial downstream side Xd. Both the positive pressure surface 31 and the negative pressure surface 32 are directed in a direction including a component of the circumferential direction θ and connect the leading edge LE and the trailing edge TE to each other. The positive pressure surface 31 is directed to a rotation side of the rotary shaft portion 21 in the circumferential direction θ. In addition, the negative pressure surface 32 is directed to a reverse rotation side of the rotary shaft portion 21 in the circumferential direction θ. That is, the positive pressure surface 31 and the negative pressure surface 32 have a back-to-back relationship. The tip portion 33x faces the casing 10 with a clearance therebetween and connects the leading edge LE and the trailing edge TE to each other.

The clearance in the tip portion 33x of the comparative example is a clearance CLn which is substantially uniform throughout the entire region of the tip portion 33x. Thus, in a chord direction Dc in which a chord Ch of this blade 30x extends, both a clearance at a position of the leading edge LE of this blade 30x and a clearance at a position of the trailing edge TE of this blade 30x are the clearance CLn. This clearance CLn is a nominal clearance of the blade 30x of the comparative example.

For example, as indicated in the following Expression (1), this clearance CLn is 2% of a span·S.

CLn=0.02·S (1)

The span S is a distance from a proximal part of the blade 30x to the casing 10. However, the span changes with a position in the axial direction X or the chord direction Dc. Therefore, here, the span at a centroid position of the blade 30x in the axial direction X or the chord direction Dc will be referred to as the span S. In addition, all of the dimensions of the portions indicated below are dimensions in a state where the compressor is not operating and the compressor is being cooled.

A distance from the axis Ar to the intersection point of the tip portion 33x and the leading edge LE, that is, a radius RLE of the leading edge LE, and a distance from the axis Ar to the intersection point of the tip portion 33x and the trailing edge TE, that is, a radius RTE of the trailing edge TE have a relationship indicated in the following Expression (2).

RLE≥RTE (2)

As above, when there is the clearance CLn between the blade 30x and the casing 10, in a first blade, a second blade, and a third blade arranged in the circumferential direction θ, for example, a portion of a gas flowing between the first blade and the second blade passes through the clearance between the second blade and the casing 10 and flows into a space between the second blade and the third blade. A leakage gas which is a gas passing through the clearance between the second blade and the casing 10 hinders a flow of a gas flowing between the second blade and the third blade. Therefore, when the momentum of a leakage gas increases, performance of the compressor deteriorates. Moreover, operational stability of the compressor deteriorates, and it leads to a stall of the compressor in some cases.

The momentum of a leakage gas, in a case where the nominal clearance CLn of the comparative example was changed, was subjected to computational fluid dynamics (CFD) calculation, and the calculation result illustrated in FIG. 9 was obtained. For example, as illustrated in FIG. 9, when the nominal clearance CLn is 0.03·S (3% of the span S), the position of the maximum momentum generated by a leakage gas becomes a position of 25% of a chord length ChL from the leading edge LE in the chord direction Dc. In addition, regarding the momentum of a leakage gas, the momentum of a leakage gas is basically larger in a case where the clearance is large than in a case where the clearance is small at any position in the chord direction Dc.

It is assumed that the momentum of a leakage gas is the maximum at the position of 25% of the chord length ChL from the leading edge LE in the chord direction Dc. In this case, since the position of 25% of the chord length ChL from the leading edge LE in the chord direction Dc is close to the leading edge LE, this leakage gas also affects an adjacent blade 30x in the circumferential direction θ. That is, in this case, a portion of a gas flowing between the first blade and the second blade passes through the clearance between the second blade and the casing 10 and flows into a space between the second blade and the third blade as a leakage gas. Moreover, this leakage gas also affects the third blade. In this manner, a phenomenon in which both the second blade and the third blade adjacent to each other in the circumferential direction θ are affected is referred to as double leakage. This double leakage more adversely affects performance and operational stability of the compressor, compared to a case where there is no double leakage.

Next, the compressor of the present embodiment will be described. Similar to the compressor of the comparative example, the compressor of the present embodiment is also an axial compressor.

Similar to the compressor of the comparative example, as illustrated in FIG. 1, the compressor of the present embodiment also includes a rotor 20 that rotates about the axis Ar, the casing 10 that covers the outer circumferential side of the rotor 20, and the plurality of stator vane rows 15.

The rotor 20 has the rotary shaft portion 21 extending in the axial direction X about the axis Ar, and the plurality of blade rows 22 provided in the rotary shaft portion 21 at intervals in the axial direction X. All of the blade rows 22 have a plurality of blades 30 arranged in the circumferential direction θ.

Each of the plurality of stator vane rows 15 is disposed on the axial downstream side Xd of any blade row 22 of the blade rows 22. In other words, each of the plurality of blade rows 22 is disposed on the axial upstream side Xu of any stator vane row 15 of the plurality of stator vane rows 15. All of the stator vane rows 15 have the plurality of stator vanes 16 arranged in the circumferential direction θ. All of the plurality of stator vanes 16 are fixed to the casing 10.

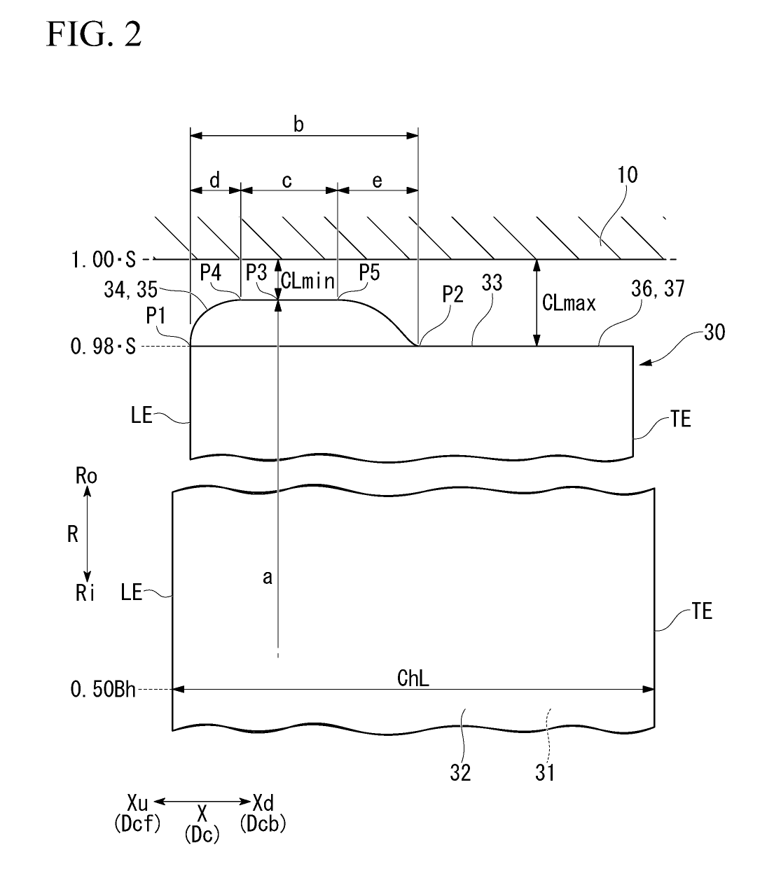

As illustrated in FIGS. 2 and 4, similar to the blade 30x of the comparative example, the blade 30 has the leading edge LE, the trailing edge TE, the positive pressure surface 31, the negative pressure surface 32, and a tip portion 33. The leading edge LE forms an edge of the blade 30 on the axial upstream side Xu. The trailing edge TE forms an edge of the blade 30 on the axial downstream side Xd. Both the positive pressure surface 31 and the negative pressure surface 32 are directed in a direction including a component of the circumferential direction θ and connect the leading edge LE and the trailing edge TE to each other. The positive pressure surface 31 is directed to the rotation side of the rotary shaft portion 21 in the circumferential direction θ. In addition, the negative pressure surface 32 is directed to the reverse rotation side of the rotary shaft portion 21 in the circumferential direction θ. That is, the positive pressure surface 31 and the negative pressure surface 32 have a back-to-back relationship. The tip portion 33 faces the casing 10 with a clearance therebetween and connects the leading edge LE and the trailing edge TE to each other.

The tip portion 33 of the present embodiment differs from the tip portion 33x of the comparative example. The tip portion 33 of the present embodiment has an upstream-side region 34 including the leading edge LE, and a downstream-side region 36 including the trailing edge TE. The upstream-side region 34 has a small clearance formation portion 35. The downstream-side region 36 forms a large clearance formation portion 37 throughout the entire region of this downstream-side region 36. The small clearance formation portion 35 includes a part in which the clearance is the minimum in the tip portion 33.

As illustrated in FIG. 4, in the small clearance formation portion 35, the shape of a cross section perpendicular to the axis Ar is a semicircular shape at any position in the chord direction Dc in which the chord Ch of this blade 30 extends. Therefore, in the small clearance formation portion 35, the clearance is gradually reduced from the positive pressure surface 31 toward the negative pressure surface 32 side, and the clearance is the minimum at an intermediate position between the positive pressure surface 31 and the negative pressure surface 32 in the circumferential direction θ. Then, in the small clearance formation portion 35, the clearance is gradually increased from the intermediate position between the positive pressure surface 31 and the negative pressure surface 32 while being closer to the negative pressure surface 32. In this manner, in the small clearance formation portion 35 of the present embodiment, the clearance changes in accordance with the position in the circumferential direction θ.

The downstream-side region 36 extends to the trailing edge TE from an edge of the small clearance formation portion 35 on a trailing edge side Dcb, that is, an edge P2 on the axial downstream side Xd. A clearance of the large clearance formation portion 37 is larger than the clearance of the small clearance formation portion 35. The clearance of the large clearance formation portion 37 of the present embodiment is a largest clearance CLmax of the blade 30 of the present embodiment in the entire region of the large clearance formation portion 37 (that is, the downstream-side region 36).

The blade 30 of the present embodiment is produced as follows.

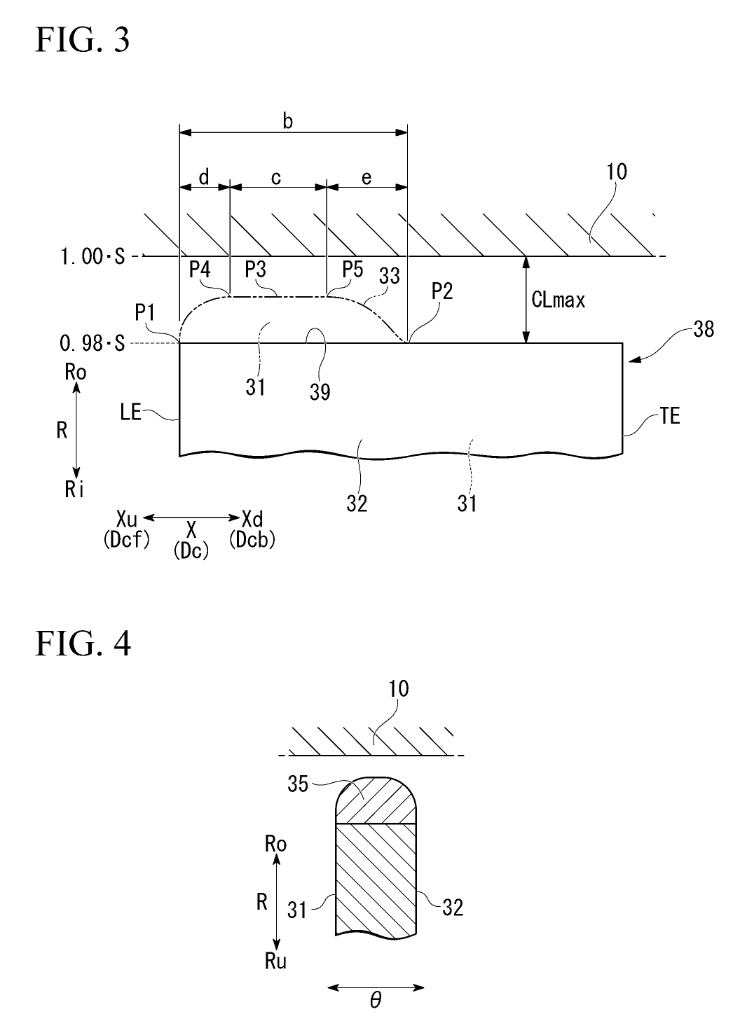

First, as illustrated in FIG. 3, an intermediate product 38 of the blade 30 is formed (intermediate product-forming step). Next, this intermediate product 38 is machined (machining step).

The intermediate product 38 formed in the intermediate product-forming step is formed of a metal such as stainless steel, for example. This intermediate product 38 has the leading edge LE, the trailing edge TE, the positive pressure surface 31, the negative pressure surface 32, and an unmachined tip portion 39. The unmachined tip portion 39 faces the casing 10. A clearance of the unmachined tip portion 39 is substantially the same clearance as the largest clearance CLmax of the large clearance formation portion 37 in a machined tip portion 33 throughout the entire region in the chord direction Dc of this unmachined tip portion 39. That is, the unmachined tip portion 39 of the intermediate product 38 is substantially the same as the tip portion 33x of the blade 30x of the comparative example. Therefore, the clearance of this unmachined tip portion 39, in other words, the largest clearance CLmax of the large clearance formation portion 37 is substantially the same as a nominal clearance CLn of the blade 30x of the comparative example. Thus, the intermediate product 38 is substantially the same as the blade 30x of the comparative example. The machined tip portion 33 is the tip portion 33 realized when the blade 30 is brought to completion.

In the machining step, the unmachined tip portion 39 of the intermediate product 38 is machined to form the machined tip portion 33 which is the tip portion 33 realized when being brought to completion. Thus, as illustrated in FIG. 2, this machined tip portion 33 has the upstream-side region 34 including the leading edge LE, and the downstream-side region 36 including the trailing edge TE. The upstream-side region 34 has the small clearance formation portion 35 including the part in which the clearance is the minimum in the tip portion 33. The downstream-side region 36 extends from the edge P2 of the small clearance formation portion 35 on the trailing edge side Dcb (axial downstream side Xd) to the trailing edge TE. This downstream-side region 36 forms the large clearance formation portion 37 having a clearance larger than the clearance of the small clearance formation portion 35 throughout the entire region of the downstream-side region 36.

Specifically, in the machining step, the small clearance formation portion 35 is formed by forming a part which becomes the small clearance formation portion 35 in the unmachined tip portion 39, as a ridge with a metal material, for example, stainless steel for forming the small clearance formation portion 35. Methods of forming a ridge using a metal material include welding.

When the machining step is completed, the blade 30 is basically brought to completion. However, as necessary, in order to have the shape and the dimensions of a machined product adapted after the machining step, finishing such as grinding may be performed for a surface of this machined product.

Next, the dimensions and the like of each of the portions of the blade 30 will be described in detail with reference to FIG. 2.

A smallest clearance CLmin of the blade 30 is also the smallest clearance CLmin in the small clearance formation portion 35. As indicated in the following Expression (3), this smallest clearance CLmin is equal to or larger than 0.4% of the chord length ChL and is less than the largest clearance CLmax.

CLmax>CLmin≥0.004·ChL (3)

The chord length ChL in this case is the chord length ChL at a position of 50% of a blade height Bh. The blade height Bh is a distance from a proximal part of the blade 30 to a tip. In addition, the largest clearance CLmax in this case is within a range of 2% to 3% of the span S, for example.

Therefore, a distance a from the proximal part of the blade 30 to a position P3 of the smallest clearance CLmin in the blade 30 in the radial direction R is determined based on the smallest clearance CLmin restricted as above. That is, the value obtained by subtracting the smallest clearance CLmin from the span S becomes the distance a.

As indicated in the following Expression (4), the position P3 of the smallest clearance CLmin in the chord direction Dc is a position at any distance within a range of 5% to 60% of the chord length ChL from the leading edge LE.

0.05·ChL≤P3≤0.60·ChL (4)

As indicated in the following Expression (5), the position P3 of the smallest clearance CLmin in the chord direction Dc is preferably a position at any distance within a range of 10% to 60% of the chord length ChL from the leading edge LE.

0.10·ChL≤P3≤0.60·ChL (5)

In the present embodiment, a region c in the diagram is a smallest clearance formation region c indicating the smallest clearance CLmin in the chord direction Dc.

In the unmachined tip portion 39 of the intermediate product 38, a ridge region b ridged with a material for forming the small clearance formation portion 35 includes the smallest clearance formation region c described above. Therefore, the edge P2 of the ridge region b on the trailing edge side Dcb in the chord direction Dc is on the trailing edge side Dcb of the smallest clearance formation region c. In addition, an edge P1 of the ridge region b on a leading edge side Dcf in the chord direction Dc is on the leading edge side Dcf of the smallest clearance formation region c.

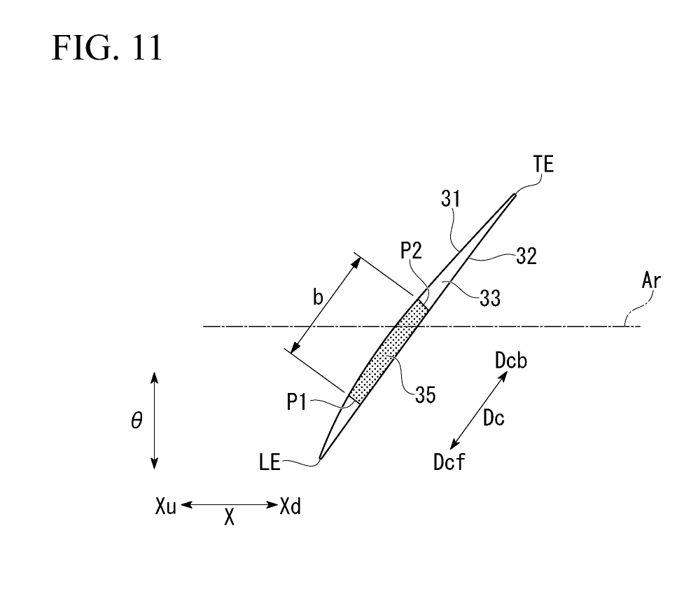

In the present embodiment, the edge P1 of the ridge region b on the leading edge side Dcf in the chord direction Dc is the position of the leading edge LE in the chord direction Dc. However, as indicated in the following Expression (6), the edge P1 of the ridge region b on the leading edge side Dcf may be a position at any distance within a range of 0% to 25% of the chord length ChL from the leading edge LE. Thus, as illustrated in FIG. 11, the edge P1 of the ridge region b on the leading edge side Dcf does not have to be the position of the leading edge LE in the chord direction Dc.

0.00·ChL≤P3≤0.25·ChL (6)

It is preferable that the position of the smallest clearance formation region c and the position of the ridge region b in the chord direction Dc described above be determined based on the position of the maximum momentum generated by a leakage gas. Specifically, at least the smallest clearance formation region c is caused to be present at the position of the maximum momentum generated by a leakage gas in the chord direction Dc. Moreover, the edge P1 of the ridge region b on the leading edge side Dcf is caused to be present on the leading edge side Dcf of this position, and the edge P2 of the ridge region b on the trailing edge side Dcb is caused to be present on the trailing edge side Dcb of this position.

Within a region d from the leading edge LE to an edge P4 of the smallest clearance formation region c on the leading edge side Dcf via the edge P1 of the ridge region b on the leading edge side Dcf, the clearance with respect to the casing 10 at the position thereof smoothly changes with respect to a positional change in the chord direction Dc. Therefore, in the present embodiment, an impact of a gas on the region d can be alleviated.

In addition, within the region d from an edge P5 of the smallest clearance formation region c on the trailing edge side Dcb to the edge P2 of the ridge region b on the trailing edge side Dcb as well, the clearance with respect to the casing 10 at the position thereof smoothly changes with respect to a positional change in the chord direction Dc.

As above, there is no need for the clearance at the position thereof to be uniform with respect to a positional change in the chord direction Dc within the ridge region b. For example, as illustrated in FIG. 10, the shape of the small clearance formation portion 35 viewed in the circumferential direction θ may form a semielliptical shape. In this case, the clearance is gradually reduced from the edge P1 of the ridge region b on the leading edge side Dcf toward the trailing edge side Dcb. Then, the clearance becomes the smallest clearance CLmin at a position on the trailing edge side Dcb of the edge P1. The region of the smallest clearance CLmin in this case substantially has no width in the chord direction Dc. Moreover, the clearance is gradually increased from the position of this smallest clearance CLmin while being closer to the edge P2 of the ridge region b on the trailing edge side Dcb. In addition, in the foregoing description, there is only one smallest clearance formation region c in the chord direction Dc, but smallest clearance formation regions c may be studded at a plurality of places in the chord direction Dc. That is, as long as the position of the smallest clearance CLmin is a position satisfying Expression (4) or Expression (5) described above, the clearance at the position thereof with respect to a positional change in the chord direction Dc within the ridge region b may be arbitrary. However, the smallest clearance CLmin needs to satisfy Expression (3) described above.

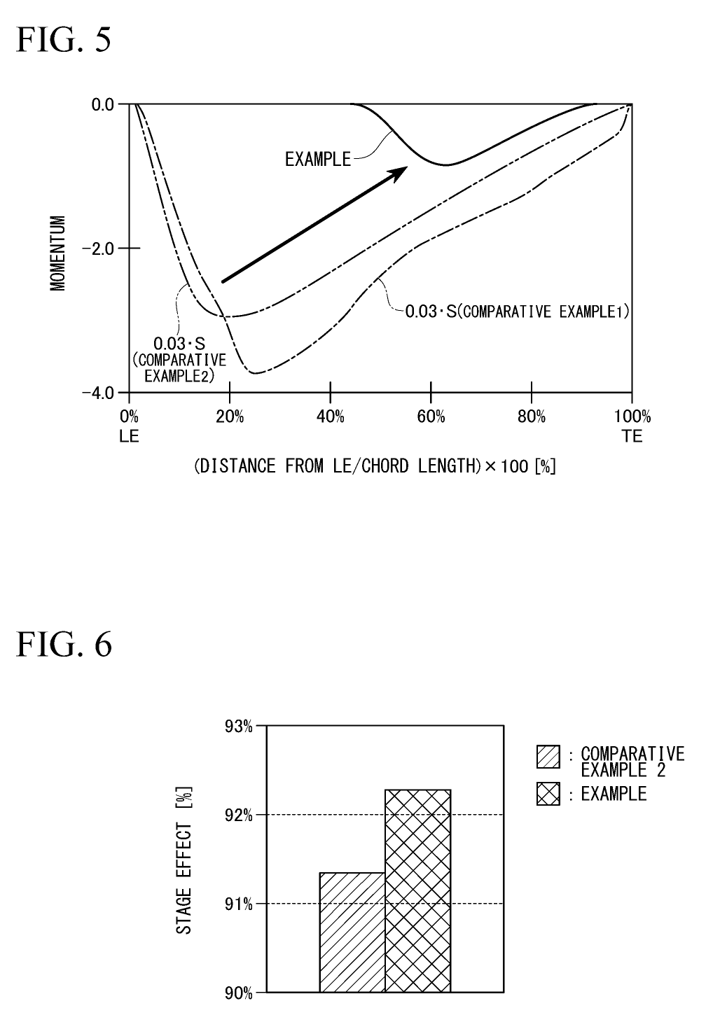

Next, effects of the compressor of the present embodiment will be described using FIG. 5. FIG. 5 is data obtained through CFD calculation. This FIG. 5 illustrates a relationship between a distance from the leading edge LE of the blade and a momentum of a leakage gas regarding a comparative example 1 having the nominal clearance CLn of 0.03S, a comparative example 2 having the nominal clearance CLn of 0.03S, and an example of the present embodiment. The comparative example 1 is the comparative example in FIG. 9. In addition, although the comparative example 2 has the nominal clearance CLn of 0.03 S similar to the comparative example 1, it differs from the comparative example 1 in vane shape.

In the blade 30 of the example of the present embodiment, the position of the maximum momentum generated by a leakage gas deviates to the trailing edge side Dcb of the blades of the comparative examples 1 and 2 having the nominal clearance CLn of 0.03 S. Specifically, in this example, the position of the maximum momentum generated by a leakage gas becomes the position of approximately 60% of the chord length ChL from the leading edge LE in the chord direction Dc. Furthermore, in this example, the maximum momentum of a leakage gas becomes approximately ⅓ or less than ⅓ of those of the blades of the comparative examples 1 and 2.

Therefore, in this example, as illustrated in FIG. 6, for example, it is possible to further enhance the performance of one blade row, in other words, the effect of one stage compared with that of the comparative example 2 by approximately nine percent.

Thus, in the present embodiment, it is possible to curb deterioration in performance of the compressor caused by the influence of a leakage gas while ensuring a clearance between the casing 10 and the blade 30.

Incidentally, when starting or stopping the compressor, the clearance changes due to a thermal expansion difference generated between the rotor 20 and the casing 10. Therefore, when starting or stopping the compressor, there is a possibility that the tip portion 33 of the blade 30 and the casing 10 may come into contact with each other.

In the axial compressor, the inner diameter of the casing 10 is gradually reduced toward the axial downstream side Xd. If the trailing edge TE of the blade 30 relatively moves to the axial downstream side Xd with respect to the casing 10 due to a thermal expansion difference between the rotor 20 and the casing 10, a possibility of contact between the downstream-side region 36 including the trailing edge TE in the tip portion 33 and the casing 10 increases. However, in the present embodiment, since the downstream-side region 36 of the tip portion 33 forms the large clearance formation portion 37 throughout the entire region, a possibility of contact between the downstream-side region 36 and the casing 10 can be further reduced compared with a case where the entire region of the tip portion 33 serves as the small clearance formation portion 35.

In addition, as described above, in the small clearance formation portion 35 of the present embodiment, the clearance changes in accordance with the position in the circumferential direction θ. Therefore, even if the small clearance formation portion 35 and the casing 10 come into contact with each other, only a portion of the small clearance formation portion 35 in the circumferential direction θ comes into contact therewith, so that it is possible to curb damage to the small clearance formation portion 35 caused by contact therebetween.

In the present embodiment, the small clearance formation portion 35 is formed by forming the unmachined tip portion 39 of the intermediate product 38 as a ridge with a metal material, and cutting the metal material as necessary. Therefore, the small clearance formation portion 35 is easily formed into a target shape. In other words, the tip portion 33 can be easily formed into various shapes by forming the tip portion 33 as in the present embodiment.

In a part constituting the blade 30, the material for forming the small clearance formation portion 35 and the material for forming other parts may be the same or may be different materials. For example, the material for forming the small clearance formation portion 35 may be a material having better abradable properties than the material for forming other parts. The expression better abradable properties in this case indicates that the material for forming the small clearance formation portion 35 is more likely to be cut than the material for forming other parts when coming into contact with the casing 10. Thus, for example, the material for forming the small clearance formation portion 35 may be a softer material than the material for forming other parts. Specifically, for example, when other parts are formed of a Cr-based alloy, the small clearance formation portion 35 may be formed of softer stainless steel than this Cr-based alloy. In addition, when other parts are formed of a certain stainless steel, the small clearance formation portion 35 may be formed of another stainless steel softer than this stainless steel.

In the small clearance formation portion 35 of the foregoing embodiment, the shape of a cross section perpendicular to the axis Ar is a semicircular shape at any position in the chord direction Dc. However, the shape of a cross section of the small clearance formation portion 35 perpendicular to the axis Ar is not limited thereto.

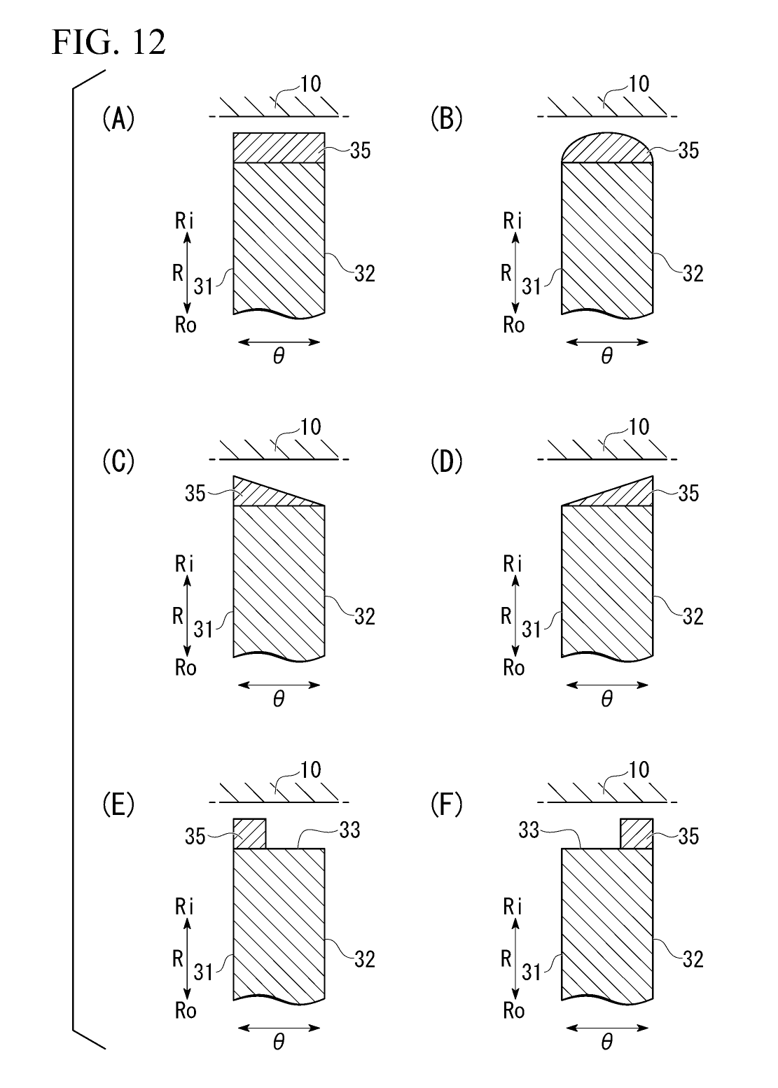

For example, the shape of a cross section of the small clearance formation portion 35 perpendicular to the axis Ar may be shapes illustrated in FIGS. 12(A) to 12(F). Specifically, as illustrated in FIG. 12(A), the shape of a cross section of the small clearance formation portion 35 may be a rectangular shape. In this case, one side of the rectangular shape is flush with the positive pressure surface 31 of the blade 30, and another side opposite to this side is flush with the negative pressure surface 32 of the blade 30.

In addition, as illustrated in FIG. 12(B), the shape of a cross section of the small clearance formation portion 35 may be a semielliptical shape.

In addition, as illustrated in FIGS. 12(C) and 12(D), the shape of a cross section of the small clearance formation portion 35 may be a right-triangular shape. In this case, the hypotenuse of the right triangle faces the casing 10, and one side of the remaining two sides is flush with the positive pressure surface 31 or the negative pressure surface 32 of the blade 30.

In addition, as illustrated in FIGS. 12(E) and 12(F), the small clearance formation portion 35 may be present in only a portion of the tip portion 33 of the blade 30 in the circumferential direction θ. In this case, one side of the small clearance formation portion 35 is flush with only one surface of the positive pressure surface 31 and the negative pressure surface 32 of the blade 30. In this manner, it is possible to reduce the vane thickness of the tip portion 33 by causing the small clearance formation portion 35 to be biased to one surface side of the positive pressure surface 31 and the negative pressure surface 32 of the blade 30.

The clearance of the upstream-side region 34 of the tip portion 33 in FIGS. 12(B) to 12(C) described above changes in accordance with the position in the circumferential direction θ. Therefore, even if the small clearance formation portion 35 and the casing 10 illustrated in FIGS. 12(B) to 12(C) come into contact with each other, only a portion of the small clearance formation portion 35 in the circumferential direction θ comes into contact therewith, so that it is possible to curb damage to the small clearance formation portion 35 caused by contact therebetween.

### Second Embodiment

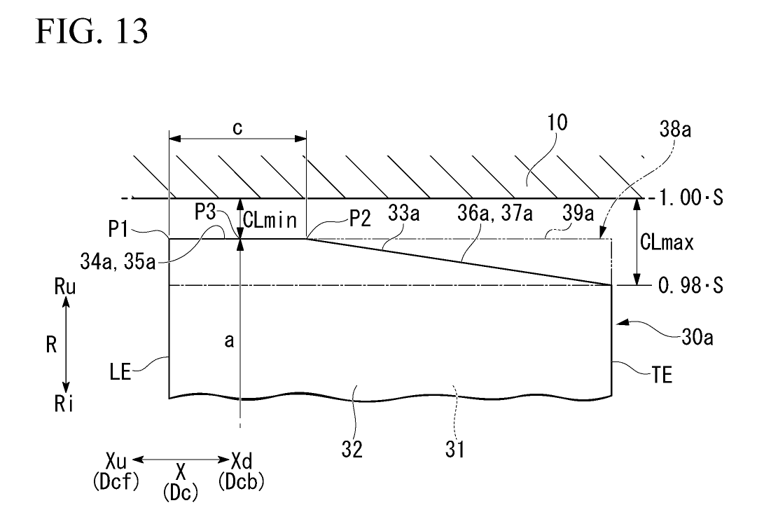

With reference to FIG. 13, a second embodiment of the compressor will be described.

The compressor of the present embodiment differs from the compressor of the first embodiment in only the blade. Thus, hereinafter, a blade 30a of the compressor of the present embodiment will be described in detail.

Similar to the blade 30 of the first embodiment, the blade 30a of the present embodiment also has the leading edge LE, the trailing edge TE, the positive pressure surface 31, the negative pressure surface 32, and a tip portion 33a.

Similar to the tip portion 33 of the first embodiment, the tip portion 33a of the present embodiment also has an upstream-side region 34a including the leading edge LE, and a downstream-side region 36a including the trailing edge TE. The upstream-side region 34a has a small clearance formation portion 35a. The downstream-side region 36a forms a large clearance formation portion 37a throughout the entire region of this downstream-side region 36a. The clearance of the small clearance formation portion 35a is the smallest clearance CLmin throughout the entire region of the chord direction Dc. On the other hand, the clearance of the large clearance formation portion 37a is gradually increased from the edge of the small clearance formation portion 35a on the trailing edge side Dcb toward the trailing edge TE. Therefore, the position of the largest clearance CLmax in the large clearance formation portion 37a is the position of the trailing edge TE in the chord direction Dc.

Similar to the first embodiment, the shape of a cross section of the small clearance formation portion 35a perpendicular to the axis Ar may be basically any shape.

The blade 30a of the present embodiment is produced as follows.

In the present embodiment, similar to the first embodiment, the intermediate product-forming step of forming an intermediate product 38a of the blade 30a, and the machining step of machining this intermediate product 38a are executed.

The intermediate product 38a formed in the intermediate product-forming step is formed of a metal such as stainless steel, for example. Similar to the intermediate product 38 of the first embodiment, this intermediate product 38a also has the leading edge LE, the trailing edge TE, the positive pressure surface 31, the negative pressure surface 32, and an unmachined tip portion 39a. However, the clearance of the unmachined tip portion 39a of the present embodiment is equal to or less than the smallest clearance CLmin of a machined tip portion 33a throughout the entire region which is the tip portion 33a realized when being brought to completion in the chord direction Dc in this unmachined tip portion 39a. In other words, the vane height of the intermediate product 38a is equal to or larger than the vane height of a finished product.

In the machining step, the unmachined tip portion 39a of the intermediate product 38a is machined to form the machined tip portion 33a which is the tip portion 33a realized when being brought to completion. Specifically, in this machining step, the large clearance formation portion 37a is formed by cutting a part which becomes the large clearance formation portion 37a in the unmachined tip portion 39a. In addition, as necessary, the clearance of this small clearance formation portion 35a is caused to be the smallest clearance CLmin throughout the entire region of the chord direction Dc by cutting a part which becomes the small clearance formation portion 35a in the unmachined tip portion 39a.

When the machining step is completed, the blade 30a is basically brought to completion. However, as necessary, in order to have the shape and the dimensions of a machined product adapted after the machining step, finishing such as grinding may be performed for a surface of this machined product.

Next, the dimensions and the like of each of the portions of the blade 30a of the present embodiment will be described in detail.

The smallest clearance CLmin of the blade 30a is also the smallest clearance CLmin in the small clearance formation portion 35a. Similar to the smallest clearance CLmin of the first embodiment, the smallest clearance CLmin of the present embodiment is equal to or larger than 0.4% of the chord length ChL and is smaller than the largest clearance CLmax as well. The largest clearance CLmax of the present embodiment is also within a range of 2% to 3% of the span S, for example.

Therefore, the distance a from the proximal part of the blade 30a to the position P3 of the smallest clearance CLmin in the blade 30a in the radial direction R is determined based on the smallest clearance CLmin restricted as above. That is, the value obtained by subtracting the smallest clearance CLmin from the span S becomes the distance a.

As described below, similar to the position P3 of the smallest clearance CLmin of the first embodiment, the position P3 of the smallest clearance CLmin in the chord direction Dc is also a position at any distance within a range of 5% to 60% of the chord length ChL from the leading edge LE.

As described below, the position P3 of the smallest clearance CLmin in the chord direction Dc is preferably a position at any distance within a range of 10% to 60% of the chord length ChL from the leading edge LE.

In the present embodiment, as described above, the clearance of the small clearance formation portion 35a is the smallest clearance CLmin throughout the entire region of the chord direction Dc. Therefore, the small clearance formation portion 35a differs from that of the first embodiment and forms the smallest clearance formation region c throughout the entire region of the chord direction Dc.

The position of an edge of the small clearance formation portion 35a on the leading edge side Dcf, in other words, the position of the edge P1 of the smallest clearance formation region c on the leading edge side Dcf is the position of the leading edge LE in the chord direction Dc. In addition, the position of the edge of the small clearance formation portion 35a on the trailing edge side Dcb, in other words, the position of the edge P2 of the smallest clearance formation region c on the trailing edge side Dcb is a position at any distance within a range of 10% to 60% of the chord length ChL from the leading edge LE.

As described above, the clearance of the large clearance formation portion 37a is gradually increased from the edge P2 of the small clearance formation portion 35a on the trailing edge side Dcb toward the trailing edge side Dcb. More specifically, the clearance of the large clearance formation portion 37a linearly changes in accordance with a positional change in the chord direction Dc from the edge P2 of the small clearance formation portion 35a on the trailing edge side Dcb forming the smallest clearance CLmin to the position of the trailing edge TE in the chord direction Dc forming the largest clearance CLmax. In other words, the large clearance formation portion 37a is a part in which the edge P1 of the small clearance formation portion 35a on the trailing edge side Dcb forming the smallest clearance CLmin and the position of the trailing edge TE in the chord direction Dc forming the largest clearance CLmax are joined to each other substantially in a straight line shape. The edge P2 of the small clearance formation portion 35a on the trailing edge side Dcb forming the smallest clearance CLmin and the position of the trailing edge TE in the chord direction Dc forming the largest clearance CLmax may be joined to each other in a curved line shape.

Hereinabove, in the present embodiment, the small clearance formation portion 35a is formed in the upstream-side region 34a. Therefore, in the example of the present embodiment, as described using FIG. 5, the position of the maximum momentum generated by a leakage gas deviates to the trailing edge side Dcb of the blades of the comparative examples 1 and 2 having the nominal clearance CLn of 0.03 S. Specifically, in this example, the position of the maximum momentum generated by a leakage gas becomes the position of approximately 60% of the chord length ChL from the leading edge LE in the chord direction Dc. Furthermore, in this example, the maximum momentum of a leakage gas becomes approximately ⅓ or less than ⅓ of those of the blades of the comparative examples 1 and 2.

Therefore, in the example of the present embodiment, as described using FIG. 6, it is possible to further enhance the performance of one blade row, in other words, the effect of one stage compared with that of the comparative example 2 by approximately nine percent.

Thus, in the present embodiment, it is possible to curb deterioration in performance of the compressor caused by the influence of a leakage gas while ensuring a clearance between the casing 10 and the blade 30a.

In addition, in the present embodiment, since the downstream-side region 36a of the tip portion 33a forms the large clearance formation portion 37a throughout the entire region, a possibility of contact between the downstream-side region 36a and the casing 10 can be further reduced compared with a case where the entire region of the tip portion 33a serves as the small clearance formation portion 35a.

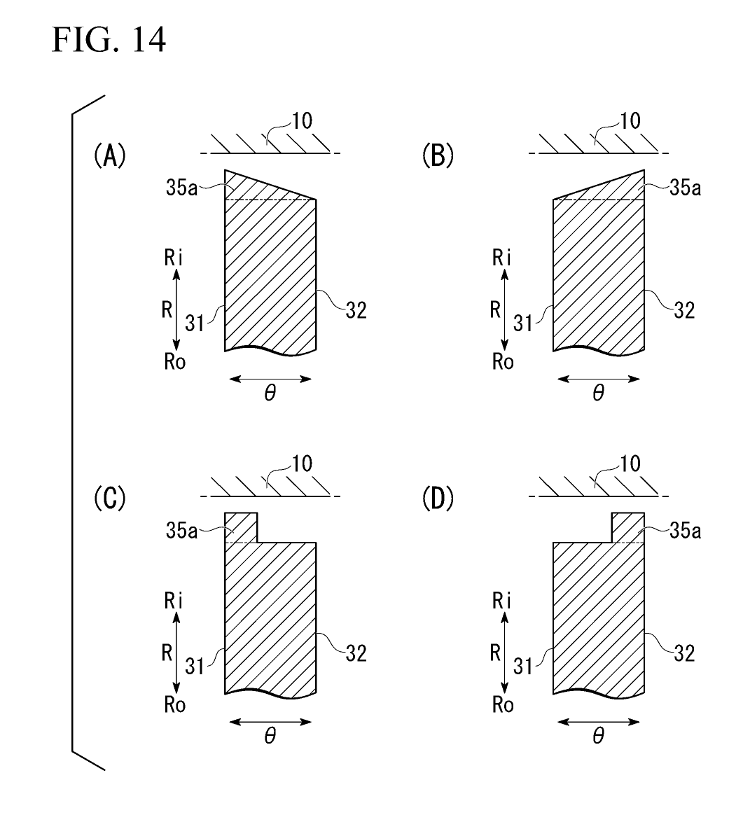

The shape of a cross section of the small clearance formation portion 35a perpendicular to the axis Ar in the present embodiment may be shapes illustrated in FIGS. 14(A) to 14(D), for example. Specifically, as illustrated in FIGS. 12(A) and 12(B), the shape of a cross section of the small clearance formation portion 35a may be a right-triangular shape. In this case, the hypotenuse of the right triangle faces the casing 10, and one side of the remaining two sides is flush with the positive pressure surface 31 or the negative pressure surface 32.

In addition, as illustrated in FIGS. 14(C) and 14(D), the small clearance formation portion 35a may be present in only a portion of the tip portion 33a in the circumferential direction θ. In this case, one side of the small clearance formation portion 35a is flush with only one surface of the positive pressure surface 31 and the negative pressure surface 32. In this manner, it is possible to reduce the vane thickness of the tip portion 33a by causing the small clearance formation portion 35a to be biased to one surface side of the positive pressure surface 31 and the negative pressure surface 32.

The clearance of the upstream-side region of the tip portion 33a in FIGS. 14(A) to 14(D) described above changes in accordance with the position in the circumferential direction θ. Therefore, even if the small clearance formation portion 35a and the casing 10 illustrated in FIGS. 14(A) to 14(D) come into contact with each other, only a portion of the small clearance formation portion 35a in the circumferential direction θ comes into contact therewith, so that it is possible to curb damage to the small clearance formation portion 35a caused by contact therebetween.

In the present embodiment, as above, the unmachined tip portion 39a of the intermediate product 38a is cut to form the machined tip portion 33a which is the tip portion 33a realized when being brought to completion. As in the present embodiment, even when the unmachined tip portion 39a of the intermediate product 38a is cut, the shape of the machined tip portion 33a which is the tip portion 33a realized when being brought to completion may be the same as the shapes of the tip portions of the first embodiment or various modification examples of the first embodiment.

In addition, as in the first embodiment, even when the unmachined tip portion 39 of the intermediate product 38 is ridged with a metal material, the shape of the machined tip portion 33 which is the tip portion 33 realized when being brought to completion may be the same as the shapes of the tip portions in the second embodiment or various modification examples of the second embodiment.

In addition, in the blades 30 and 30a of the first and second embodiments, the small clearance formation portions 35 and 35a may be present at a position where the vane thickness which is an interval between the positive pressure surface 31 and the negative pressure surface 32 is the maximum in the chord direction Dc. In this manner, when the small clearance formation portions 35 and 35a are disposed, even if the small clearance formation portions 35 and 35a is formed, it is possible to curb deterioration in vibration characteristics and strength characteristics of the blades 30 and 30a. In addition, in this manner, when the small clearance formation portions 35 and 35a are disposed, it is also possible to expect improvement in aerodynamic properties of a leakage gas through the CFD calculation.

### Third Embodiment

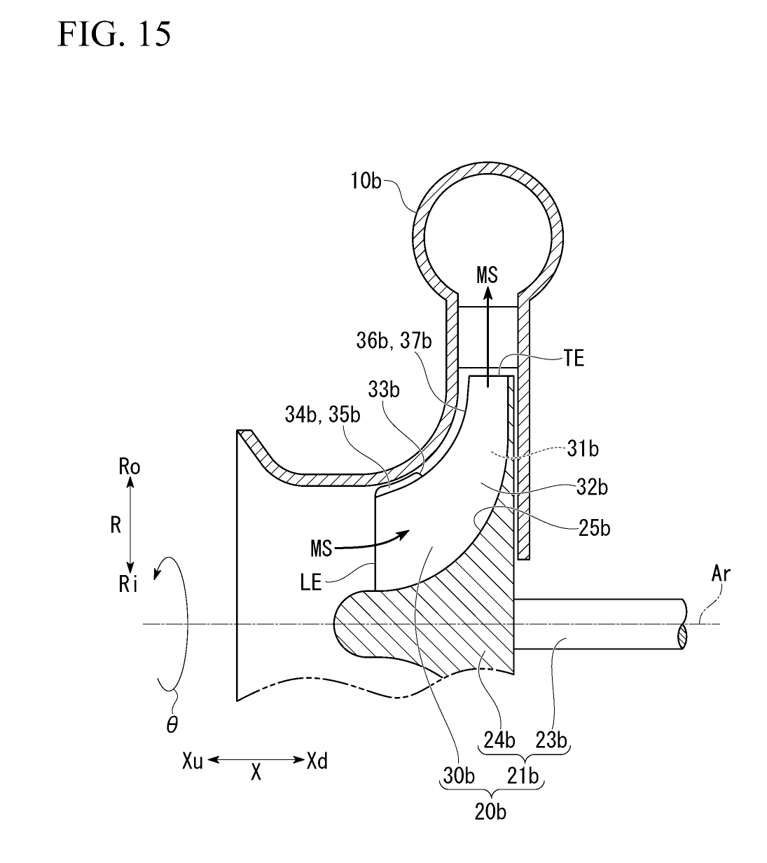

With reference to FIG. 15, a third embodiment of the compressor will be described.

The compressor of each of the foregoing embodiments is an axial compressor. On the other hand, a compressor of the present embodiment is a centrifugal compressor. The compressor of the present embodiment includes a rotor 20b that rotates about the axis Ar, and a casing 10b that covers the outer circumferential side of the rotor 20b. In the present embodiment, a direction in which the axis Ar extends will be referred to as the axial direction X. One side of this axial direction X will be referred to as the axial upstream side Xu, and the other side in this axial direction X will be referred to as the axial downstream side Xd. In addition, a side toward the axis Ar in the radial direction R with respect to the axis Ar will be referred to as the radial inner side Ri, and a side opposite thereto will be referred to as the radial outer side Ro. In addition, the circumferential direction with respect to the axis Ar will be simply referred to as the circumferential direction θ.

The rotor 20b has a rotary shaft portion 21b rotating about the axis Ar, and a plurality of blades 30b provided in the rotary shaft portion 21b. The rotary shaft portion 21b has a rotary shaft 23b extending in the axial direction X about the axis Ar, and a disk 24b fixed to the rotary shaft 23b.

The shape of the disk 24b viewed in the axial direction X is a circular shape about the axis Ar. The outer diameter of disk 24b is gradually increased from the axial upstream side Xu toward the axial downstream side Xd. Moreover, in this disk 24b, the tangential line at each of the positions on the boundary line between a surface 25b thereof and a meridian cross section has a shape directed to the radial outer side Ro in a direction nearly parallel to the axis Ar from the axial upstream side Xu toward the axial downstream side Xd. A direction in which the tangential line at the edge on the axial downstream side Xd of this disk 24b is substantially the radial outer side Ro.

The plurality of blades 30b are provided on the surface 25b of the disk 24b at intervals in the circumferential direction θ. The blades 30b protrude in a direction including a component of a direction perpendicular to the surface 25b of the disk 24b and extend from the edge of the disk 24b on the axial upstream side Xu to the edge on the axial downstream side Xd and the radial outer side Ro along the surface 25b of the disk 24b.

Similar to the foregoing embodiments, the blade 30b of the present embodiment also has the leading edge LE, the trailing edge TE, a positive pressure surface 31b, a negative pressure surface 32b, and a tip portion 33b. The leading edge LE forms an edge of the blade 30b on the axial upstream side Xu. The trailing edge TE forms an edge of the blade 30b on the radial outer side Ro. Both the positive pressure surface 31b and the negative pressure surface 32b are directed in a direction including a component of the circumferential direction θ and connect the leading edge LE and the trailing edge TE to each other. The positive pressure surface 31b is directed to the rotation side of the rotary shaft portion 21b in the circumferential direction θ. In addition, the negative pressure surface 32b is directed to the reverse rotation side of the rotary shaft portion 21b in the circumferential direction θ. That is, the positive pressure surface 31b and the negative pressure surface 32b have a back-to-back relationship. The tip portion 33b faces the casing 10b with a clearance therebetween and connects the leading edge LE and the trailing edge TE to each other.

In the axial compressor, as described above, the axial upstream side Xu is the upstream side of the main stream MS of a compressed gas, and the axial downstream side Xd is the downstream side of the main stream MS. However, in the centrifugal compressor, the axial upstream side Xu is the upstream side of the main stream MS of a compressed gas, and the radial outer side Ro is the downstream side of the main stream MS. Therefore, as described above, the trailing edge TE of the blade 30b in the centrifugal compressor forms the edge of the blade 30b on the radial outer side Ro, in other words, the edge of the blade 30b on the downstream side of the main stream MS. In the axial compressor and the centrifugal compressor, the leading edge LE forms the edge of the blade on the upstream side of the main stream MS, and the trailing edge TE forms the edge of the blade on the downstream side of the main stream MS on a side opposite to the leading edge LE.

Similar to the tip portion in each of the foregoing embodiments, the tip portion 33b of the present embodiment also has an upstream-side region 34b including the leading edge LE, and a downstream-side region 36b including the trailing edge TE. The upstream-side region 34b has a small clearance formation portion 35b. The downstream-side region 36b forms a large clearance formation portion 37b throughout the entire region of this downstream-side region 36b. The downstream-side region 36b extends from the edge of the small clearance formation portion 35b on the trailing edge side to the trailing edge TE. The small clearance formation portion 35b includes a part in which the clearance is the minimum in the tip portion 33b. The clearance of the large clearance formation portion 37b is larger than the clearance of the small clearance formation portion 35b.

The blade 30b of the present embodiment may be produced by the production method described in the first embodiment or may be produced by the production method described in the second embodiment.

As in the present embodiment, even if the compressor is a centrifugal compressor, when the small clearance formation portion 35b is formed in the upstream-side region 34b, the position of the maximum momentum generated by a leakage gas deviates to the trailing edge side and the maximum momentum of a leakage gas is reduced, compared to a case where there is no small clearance formation portion 35b.

Thus, in the present embodiment, it is possible to curb deterioration in performance of the compressor caused by the influence of a leakage gas while ensuring a clearance between the casing 10b and the blade 30b.

### Fourth Embodiment

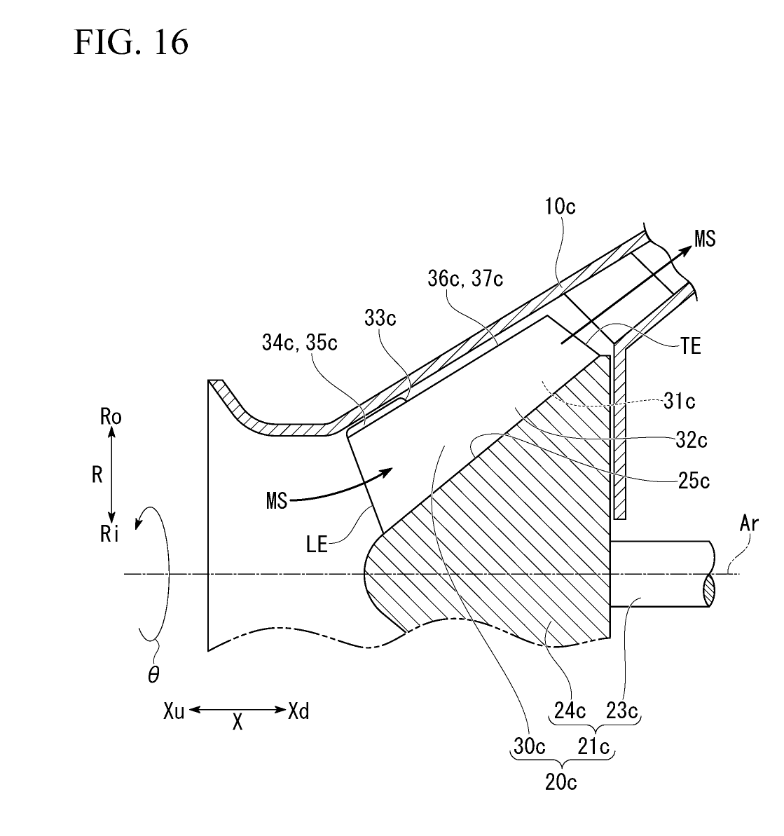

With reference to FIG. 16, a fourth embodiment of the compressor will be described.

The compressor of the present embodiment is a diagonal compressor. Similar to the centrifugal compressor of the third embodiment, the compressor of the present embodiment includes a rotor 20c that rotates about the axis Ar, and a casing 10c that covers the outer circumferential side of the rotor 20c.

Similar to the rotor 20b in the centrifugal compressor of the third embodiment, the rotor 20c has a rotary shaft portion 21c rotating about the axis Ar, and a plurality of blades 30c provided in the rotary shaft portion 21c. The rotary shaft portion 21c has a rotary shaft 23c extending in the axial direction X about the axis Ar, and a disk 24c fixed to the rotary shaft 23c.

The shape of the disk 24c viewed in the axial direction X is a circular shape about the axis Ar. The outer diameter of the disk 24c is gradually increased from the axial upstream side Xu toward the axial downstream side Xd. Moreover, in this disk 24c, similar to the disk 24b in the centrifugal compressor of the third embodiment, the tangential line at each of the positions on the boundary line between a surface 25c thereof and a meridian cross section has a shape gradually directed in the radial direction R with respect to the axis Ar in a direction nearly parallel to the axis Ar from the axial upstream side Xu toward the axial downstream side Xd. The component of a direction in which the tangential line at the edge of this disk 24c on the axial downstream side Xd extends includes a component of the axial direction and a component of the circumferential direction. That is, the component of a direction in which the tangential line at the edge of this disk 24c on the axial downstream side Xd extends has more components of the axial direction than the tangential line at the edge of the disk 24c on the axial downstream side Xd in the centrifugal compressor.

The plurality of blades 30c are provided on the surface 25c of the disk 24c at intervals in the circumferential direction θ. The blade 30c protrudes in a direction including a component of a direction perpendicular to the surface 25c of the disk 24c and extend from the edge of the disk 24c on the axial upstream side Xu to the edge on the axial downstream side Xd and the radial outer side Ro along the surface 25c of the disk 24c.

Similar to the foregoing embodiments, the blade 30c of the present embodiment also has the leading edge LE, the trailing edge TE, a positive pressure surface 31c, a negative pressure surface 32c, and a tip portion 33c. The leading edge LE forms an edge of the blade 30c on the axial upstream side Xu. The trailing edge TE forms an edge of the blade 30c on the radial outer side Ro. Both the positive pressure surface 31c and the negative pressure surface 32c are directed in a direction including a component of the circumferential direction θ and connect the leading edge LE and the trailing edge TE to each other. The positive pressure surface 31c is directed to the rotation side of the rotary shaft portion 21c in the circumferential direction θ. In addition, the negative pressure surface 32c is directed to the reverse rotation side of the rotary shaft portion 21c in the circumferential direction θ. That is, the positive pressure surface 31c and the negative pressure surface 32c have a back-to-back relationship. The tip portion 33c faces the casing 10c with a clearance therebetween and connects the leading edge LE and the trailing edge TE to each other.

In the axial compressor, as described above, the axial upstream side Xu is the upstream side of the main stream MS of a compressed gas, and the axial downstream side Xd is the downstream side of the main stream MS. However, in the diagonal compressor, the axial upstream side Xu is the upstream side of the main stream MS of a compressed gas, and a side in a direction including a component of a direction to the axial downstream side Xd and a component of a direction to the radial outer side Ro is the downstream side of the main stream MS. Therefore, the trailing edge TE of the blade 30c in the axial compressor forms an edge on the downstream side of the main stream MS.

Similar to the tip portion in each of the foregoing embodiments, the tip portion 33c of the present embodiment also has an upstream-side region 34c including the leading edge LE, and a downstream-side region 36c including the trailing edge TE. The upstream-side region 34c has a small clearance formation portion 35c. The downstream-side region 36c forms a large clearance formation portion 37c throughout the entire region of this downstream-side region 36c. The downstream-side region 36c extends from the edge of the small clearance formation portion 35c on the trailing edge side to the trailing edge TE. The small clearance formation portion 35c includes a part in which the clearance is the minimum in the tip portion 33c. The clearance of the large clearance formation portion 37c is larger than the clearance of the small clearance formation portion 35c.

Similar to the blade 30b of the third embodiment, the blade 30c of the present embodiment may be produced by the production method described in the first embodiment or may be produced by the production method described in the second embodiment.

As in the present embodiment, even if the compressor is a diagonal compressor, when the small clearance formation portion 35c is formed in the upstream-side region 34c, the position of the maximum momentum generated by a leakage gas deviates to the trailing edge side and the maximum momentum of a leakage gas is reduced, compared to a case where there is no small clearance formation portion 35c.

Thus, in the present embodiment, it is possible to curb deterioration in performance of the compressor caused by the influence of a leakage gas while ensuring a clearance between the casing 10b and the blade 30c.

### INDUSTRIAL APPLICABILITY

According to an aspect of the present invention, it is possible to curb deterioration in performance of a compressor caused by the influence of a leakage gas while ensuring a clearance between a casing and a blade.

### REFERENCE SIGNS LIST

10, 10b, 10c Casing
15 Stator vane row
16 Stator vane
20, 20b, 20c, 20x Rotor
21, 21b, 21c, 21x Rotary shaft portion
22, 22x Blade row
23b, 23c Rotary shaft
24b, 24c Disk
25b, 25c Surface of disk
30, 30a, 30b, 30c, 30x Blade
LE Leading edge
TE Trailing edge
31, 31b, 31c Positive pressure surface
32, 32b, 32c Negative pressure surface
33, 33a, 33b, 33c, 33x Tip portion (machined tip portion)
34, 34a, 34b, 34c Upstream-side region
35, 35a, 35b, 35c Small clearance formation portion
36, 36a, 36b, 36c Downstream-side region
37, 37a, 37b, 37c Large clearance formation portion
38, 38a Intermediate product
39, 39a Unmachined tip portion
Ar Axis
X Axial direction
Xu Axial upstream side
Xd Axial downstream side
R Radial direction
Ri Radial inner side
Ro Radial outer side
θ Circumferential direction
MS Main stream
S Span
Bh Blade height
Dc Chord direction
Dcf Leading edge side
Dcb Trailing edge side
ChL Chord length
CLn Nominal clearance
CLmin Smallest clearance
CLmax Largest clearance
RLE Radius of leading edge
RTE Radius of trailing edge
P1 Edge of ridge region on leading edge side
P2 Edge of ridge region on trailing edge side
P3 Position of smallest clearance
P4 Edge of smallest clearance formation region on leading edge side
P5 Edge of smallest clearance formation region on trailing edge side
A Distance from proximal part of blade to position of smallest clearance CLmin in blade
B Ridge region
c Smallest clearance formation region

1. A compressor, comprising:
a rotor that is configured to rotate about an axis; and
a casing that covers an outer circumferential side of the rotor,
wherein the rotor has a rotary shaft portion rotating about the axis, and a plurality of blades provided in the rotary shaft portion at intervals in a circumferential direction with respect to the axis,
wherein each of the plurality of blades has
a leading edge forming an edge in an axial direction in which the axis extends,
a trailing edge forming an edge on a side opposite to the leading edge,
a positive pressure surface and a negative pressure surface connecting the leading edge and the trailing edge to each other, being directed in a direction including a component of the circumferential direction, and having a back-to-back relationship therebetween, and
a tip portion connecting the leading edge and the trailing edge to each other and facing the casing with a clearance therebetween,
wherein the tip portion has an upstream-side region including the leading edge, and a downstream-side region including the trailing edge,
wherein the upstream-side region has a small clearance formation portion including a part in which the clearance is a minimum in the tip portion,
wherein the downstream-side region extends from an edge of the small clearance formation portion on the trailing edge side to the trailing edge, and
wherein the downstream-side region forms a large clearance formation portion having a clearance larger than the clearance of the small clearance formation portion throughout the entire region of the downstream-side region.

2. The compressor according to claim 1,
wherein a position of a smallest clearance which is a minimum value for the clearance is a position at a distance within a range of 5% to 60% of a chord length of the blade from the leading edge in a chord direction in which a chord of the blade extends.

3. The compressor according to claim 2,
wherein the position of the smallest clearance is a position at a distance within a range of 10% to 60% of the chord length from the leading edge in the chord direction.

4. The compressor according to claim 1,
wherein the smallest clearance which is the minimum value for the clearance is equal to or larger than 0.4% of the chord length of the blade.

5. The compressor according to claim 1,
wherein an edge of the small clearance formation portion on the leading edge side is at a position at a distance within a range of 0% to 25% of the chord length of the blade from the leading edge in the chord direction in which the chord of the blade extends.

6. The compressor according to claim 1,
wherein the small clearance formation portion is present up to a position at a distance within a range of 10% to 60% of the chord length from the leading edge in the chord direction in which the chord of the blade extends.

7. The compressor according to claim 1,
wherein in the blade, the clearance smoothly changes from the leading edge to the position of the smallest clearance which is the minimum value for the clearance.

8. The compressor according to claim 1,
wherein the small clearance formation portion includes a position where a vane thickness which is an interval between the positive pressure surface and the negative pressure surface is a maximum in the chord direction in which the chord of the blade extends.

9. The compressor according to claim 1,
wherein in the small clearance formation portion, the clearance changes in accordance with the position in the circumferential direction.

10. The compressor according to claim 1,
wherein the small clearance formation portion is present in only a portion in the upstream-side region in the circumferential direction.

11. The compressor according to claim 1,
wherein the small clearance formation portion has better abradable properties than a part in the blade excluding the small clearance formation portion.

12. The compressor according to claim 1, further comprising:
a plurality of stator vane rows that are disposed at intervals in the axial direction,
wherein all of the plurality of stator vane rows have a plurality of stator vanes fixed to the casing at intervals in the circumferential direction,
wherein the rotor has a plurality of blade rows disposed at intervals in the axial direction,
wherein each of the plurality of blade rows is disposed on an axial upstream side of any stator vane row of the plurality of stator vane rows, and
wherein all of the plurality of blade rows have a plurality of blades provided in the rotary shaft portion at intervals in the circumferential direction.

13. A method for producing a blade which rotates in a circumferential direction with respect to an axis about the axis inside a casing of a compressor, the method for executing
an intermediate product-forming step of forming an intermediate product of the blade; and
a machining step of machining the intermediate product,
wherein the intermediate product formed in the intermediate product-forming step has
a leading edge forming an edge in an axial direction in which the axis extends,
a trailing edge forming an edge on a side opposite to the leading edge,
a positive pressure surface and a negative pressure surface connecting the leading edge and the trailing edge to each other, being directed in a direction including a component of the circumferential direction, and having a back-to-back relationship therebetween, and
an unmachined tip portion facing the casing,
wherein in the machining step, the unmachined tip portion of the intermediate product is machined, the leading edge and the trailing edge are connected to each other, and a machined tip portion facing the casing with a clearance therebetween is formed,
wherein the machined tip portion has an upstream-side region including the leading edge, and a downstream-side region including the trailing edge,
wherein the upstream-side region has a small clearance formation portion including a part in which the clearance is a minimum in the tip portion,
wherein the downstream-side region extends from the edge of the small clearance formation portion on the trailing edge side to the trailing edge, and
wherein the downstream-side region forms a large clearance formation portion having a clearance larger than the clearance of the small clearance formation portion throughout the entire region of the downstream-side region.

14. The method for producing a blade according to claim 13,
wherein in the intermediate product-forming step, the intermediate product is formed such that the clearance of the unmachined tip portion becomes the same clearance as a largest clearance in the large clearance formation portion of the machined tip portion throughout the entire region of the unmachined tip portion in a chord direction in which a chord of the intermediate product extends, and
wherein in the machining step, the small clearance portion is formed by forming a part which becomes the small clearance formation portion in the unmachined tip portion, as a ridge with a material for forming the small clearance formation portion.

15. The method for producing a blade according to claim 14,
wherein a material having better abradable properties than a material for forming the intermediate product is used as the material for the small clearance formation portion.

16. The method for producing a blade according to claim 13,
wherein in the intermediate product-forming step, the intermediate product is formed such that the clearance of the unmachined tip portion becomes equal to or less than a smallest clearance in the small clearance formation portion of the machined tip portion throughout the entire region of the unmachined tip portion in a chord direction in which a chord of the intermediate product extends, and
wherein in the machining step, the large clearance formation portion is formed by cutting a part which becomes the large clearance formation portion in the unmachined tip portion.
